(19) United States
(12) Patent Application Publication
(10) Pub. No.: US 2012/0117355 A1
(43) Pub. Date: May 10, 2012

(54) Memory Management for a Dynamic Binary Translator

(75) Inventors: Neil A. Campbell, Derbyshire (GB); Geraint North, Mancheter (GB); Graham Woodward, Manchester (GB)

(73) Assignee: INTERNATIONAL BUSINESS MACHINES CORPORATION, Armonk, NY (US)

(21) Appl. No.: 13/291,275

(22) Filed: Nov. 8, 2011

(30) Foreign Application Priority Data
Nov. 10, 2010 (GB) 10190638.6

(51) Int. Cl. G06F 12/10

(52) U.S. Cl. 711/206; 711/E12.058

(57) ABSTRACT

A dynamic binary translator apparatus, method and program for translating a first block of binary computer code intended for execution in a subject execution environment having a first memory of one page size into a second block for execution in a second execution environment having a second memory of another page size, comprising a redirection page mapper responsive to a page characteristic of the first memory for mapping an address of the first memory to an address of the second memory; a memory fault behaviour detector operable to detect memory faulting during execution of the second block and to accumulate a fault count to a trigger threshold; and a regeneration component responsive to the fault count reaching the trigger threshold to discard the second block and cause the first block to be retranslated with its memory references remapped by a page table walk.

### FIELD OF THE INVENTION

The present invention relates to the field of dynamic binary translators, and more particularly to memory management in dynamic binary translators.

### BACKGROUND OF THE INVENTION

Dynamic binary translators are well known in the art of computing. Typically, such translators operate by accepting input instructions, usually in the form of basic blocks of instructions, and translating them from a subject program code form suitable for execution in one computing environment into a target program code form suitable for execution in a different computing environment. This translation is performed on the subject program code at its first execution, hence the term “dynamic”, to distinguish it from static translation, which takes place prior to execution, and which could be characterized as a form of static recompilation. In many dynamic binary translators, the basic blocks of code translated at their first execution are then saved for reuse on re-execution.

In a dynamic binary translator which is required to execute application code (the subject program) from one computer architecture and operating system, or “OS”, (the subject architecture/subject OS) on a second, incompatible computer architecture and operating system (the target architecture/target OS), one of the problems that may be faced is a difference in the page size used for memory management by the two platforms. This is a particular problem when the target OS only provides support for larger page sizes than are used by the subject OS. An example scenario is an x86 Linux® platform being emulated on Power Linux, where the subject OS provides 4 k pages but the target OS is commonly configured to provide 64 k pages. (Linux is a Registered Trademark of Linus Torvalds in the USA, other countries, or both.)

This situation causes two distinct problems:

1) Page protection cannot easily be provided at a small enough granularity to match the semantics of the subject program. For example, if the subject program wishes to allocate three adjacent pages of memory with different protection, the target OS may be unable to provide the requested allocation, as shown in FIG. 1, in which exemplary subject memory map 100 has a page size of 4 k and exemplary target memory map 102 has a page size of 64 k.

Where the subject program has applied write protection to the pages at addresses 0 and 0x2000, but not to the other pages, the translator (via the target operating system) may only write protect the region from 0 to 0x10000, so it cannot satisfy the required protection constraints of both the writable and unwritable pages.

2) Different types of memory may not be mixed together within a single target page sized region. For example, an operating system may support mappings of anonymous memory and file backed memory, where anonymous memory is visible only to the subject program which maps it, whereas changes to file-backed memory are committed back to a file in storage and may be observed by other users of that file. As the target operating system is only able to provide mappings in multiples of its own page size, the translator cannot support two different mappings within a single page.

In the example shown in FIG. 2, the subject program has mapped two pages of a file at addresses 0 and 0x2000. The target OS may only map a target page sized region; here it has chosen to map in a 64 k page of the file, but now any writes to the memory at 0x1000 (for which the subject requested anonymous memory) will now be committed back to the file, resulting in incorrect behaviour. Similar problems apply for other kinds of memory mappings, such as shared anonymous maps, where two processes may share a single region of anonymous memory, and traditional shared memory, where the operating system allocates a range of memory which is shared between different processes and may be attached to a process' address space at an arbitrary location.

Closely related to this problem is that of mapping portions of a file. Operating systems generally provide a means for mapping not just a whole file, but specific portions of a file, where the mapped portions normally begin and end at page-aligned offsets into the file. For example, for a file of length 0x40000, an application may choose to map just the region from start+0x3000 to start+0xb000. If the target operating system supports only page sized offsets, the smallest portion available for mapping would be from start to start+0x10000, which does not correspond closely enough to the subject program's request. This problem may be addressed with the same means as that of mixing map types, so for the purposes of the present disclosure the two problems will be considered to be the same.

Known approaches to the basic problem of page protection emulation are discussed here for completeness. Three existing approaches are known. The first is to modify the target operating system to allow protection at a smaller granularity, if the underlying hardware is able to support it. This can provide the required protections with no significant runtime overhead, but it may not always be feasible, as it requires modification to the operating system, and also requires that the hardware be able to support the smaller granularity.

The second approach is for the translator to provide a non-linear mapping between subject and target addresses, so that it can support any required mapping by mapping a larger than required region, and providing a page table that describes which target address contains the mapping for every given subject address. In this technique, target pages may be mapped by the translator at any address such that the required protection can be provided, and the subject addresses are translated at runtime to the corresponding target map. The translation may be performed with a traditional page table, such as that described in the Intel IA-32 architecture manual, volume 3A (this document is available on the World Wide Web at www.intel.com/Assets/PDF/manual/253668.pdf). Such a page table may be easily implemented in software, but the cost of performing the address translation for each address is high, and acceptable performance may be difficult to achieve. An example mapping according to this technique is shown in FIG. 3.

A third approach is to provide a linear mapping between subject and target addresses, but to use software to emulate only the protection. Such a technique is described in detail in published U.S. Patent document US 2010/0030975 A1. For this technique, all pages are mapped in as both readable and writable, but before each memory access operation performed on behalf of the subject program, a rapid lookup is performed which extracts the protection information from a table and inserts this information into the address to be accessed, such that accesses which should not be permitted according to the protection requested by the subject program will fault. This provides some runtime overhead, but is not as costly as a full page table lookup for each access.

For the second problem described above, three existing approaches are known, which may be considered analogous to the approaches presented above for page protection emulation.

One approach is to modify the target operating system to support mappings of small enough granularity to allow the subject programs mapping requests to be supported directly without additional emulation. This provides the lowest runtime overhead, but in practice has proved more difficult than simply providing lower granularity page protections, as the operating system must be aware of different page sizes throughout. Where the operating system is not under the complete control of the translator developers, this option may well prove impractical.

The second approach described for the page protection problem also solves the problem of mixing different maps within a single target page. By providing a non-linear translation from subject addresses to target addresses, any combination of maps may be provided such that they may appear to the subject program to exist in the requested locations, even though they may in fact be mapped elsewhere. As described above however, this approach provides a significant runtime overhead and as such overall performance may be unacceptable.

The third approach, again described in published U.S. Patent document US 2010/0030975 A1, is to protect regions (by any available means) which cannot be mapped directly at the required location, such that they cannot be accessed by the subject program. The required mapping is then made elsewhere in the address space, such that the subject program cannot access it directly. In the case where the subject program accesses these regions, a fault occurs and a signal is delivered to the translator. By inspection of the program state by the translator, it may be determined which address was being accessed, and the signal handler may at this point perform an address translation to determine the required address. The access is then emulated in the signal handler, and control is returned to the subject program having completed the operation. FIG. 4 shows how the map at address 0x4000 is protected, and how an access can be redirected by the signal handler to a portion 104 of the map at 0xF00000000.

This method provides good performance in many cases, but when the regions which cannot be accessed directly are very frequently used, the cost of handling many faults becomes prohibitive.

It is thus desirable to have an improved way of overcoming the constraints imposed on dynamic binary translators by the differences in memory management between subject computing environments and target computing environments.

### SUMMARY OF THE INVENTION

The present invention accordingly provides, in a first aspect, dynamic binary translator apparatus for translating at least one first block of binary computer code intended for execution in a subject execution environment having a first memory of a first page size into at least one second block for execution in a second execution environment having a second memory of a second page size, said second page size being different from said first page size; and comprising: a redirection page mapper responsive to a memory page characteristic of said first memory for mapping at least one address of said first memory to an address of said second memory; a memory fault behaviour detector operable to detect memory faulting during execution of said second block and to accumulate a fault count to a trigger threshold; and a regeneration component operable in response to said fault count reaching said trigger threshold to discard said second block and cause said first block to be retranslated into a retranslated block with memory references remapped by a page table walk.

Preferably, the memory page characteristic of said first memory comprises a page protection characteristic. Preferably, the memory page characteristic of said first memory comprises a file-backed memory characteristic. Preferably, the regeneration component is further operable to bypass said page table walk where said mapping at least one address of said first memory to an address of said second memory returns a same address. Preferably, the regeneration component is further operable to bypass said page table walk where a memory access is identified as a memory access to a memory of a type not requiring remapping.

In a second aspect, there is provided a method of operating a dynamic binary translator for translating at least one first block of binary computer code intended for execution in a subject execution environment having a first memory of a first page size into at least one second block for execution in a second execution environment having a second memory of a second page size, said second page size being different from said first page size; and comprising the steps of: responsive to a memory page characteristic of said first memory, mapping by a redirection page mapper at least one address of said first memory to an address of said second memory; detecting, by a memory fault behaviour detector, memory faulting during execution of said second block and accumulating a fault count to a trigger threshold; and in response to said fault count reaching said trigger threshold, discarding by a regeneration component said second block and causing said first block to be retranslated into a retranslated block with memory references remapped by a page table walk.

Preferably, the memory page characteristic of said first memory comprises a page protection characteristic. Preferably, the memory page characteristic of said first memory comprises a file-backed memory characteristic. Preferably, the regeneration component is further operable to bypass said page table walk where said mapping at least one address of said first memory to an address of said second memory returns a same address. Preferably, the regeneration component is further operable to bypass said page table walk where a memory access is identified as a memory access to a memory of a type not requiring remapping.

In a third aspect, there is provided a computer program comprising computer program code to, when loaded into a computer system and executed thereon, cause said computer system to perform the steps of a method according to the second aspect.

Preferred embodiments of the present invention thus advantageously provide an improved way of overcoming the constraints imposed on dynamic binary translators by the differences in memory management between subject computing environments and target computing environments.

### BRIEF DESCRIPTION OF THE DRAWINGS

A preferred embodiment of the present invention will now be described, by way of example only, with reference to the accompanying drawings, in which:

FIG. 1 shows, in simplified schematic form, an arrangement of subject and target memories having write protection according to the prior art;

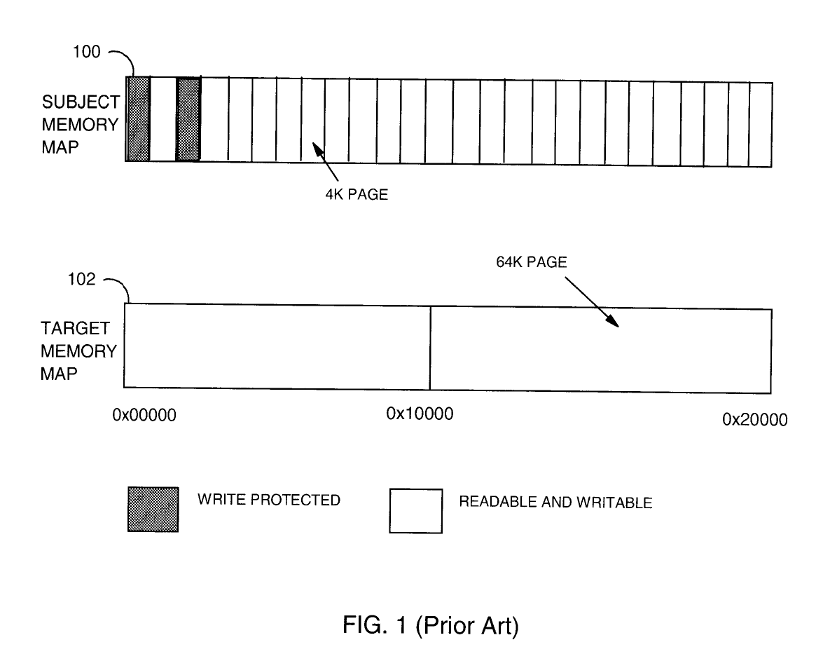

FIG. 2 shows, in simplified schematic form, an arrangement of subject and target memories having file-backed and anonymous memory according to the prior art;

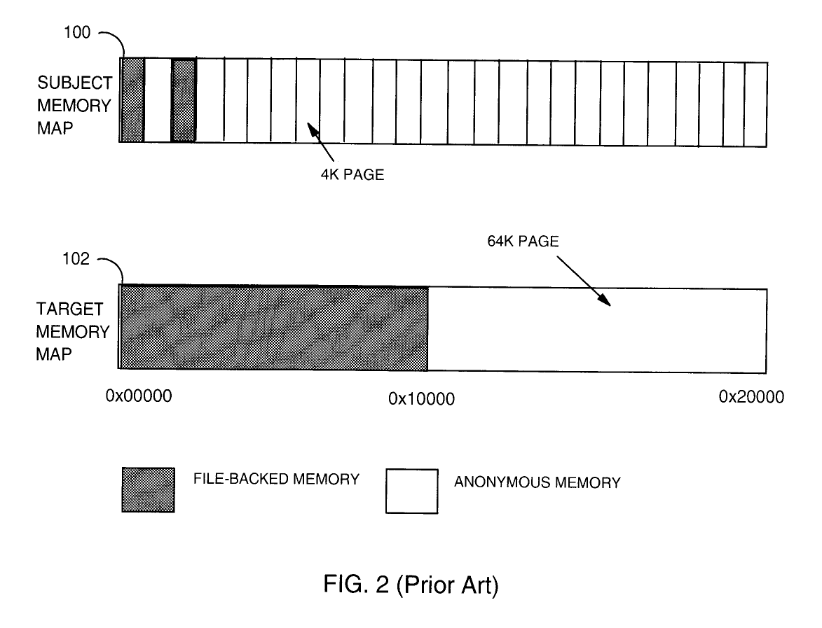

FIG. 3 shows, in simplified schematic form, an improved arrangement of subject and target memories having write protection according to the prior art;

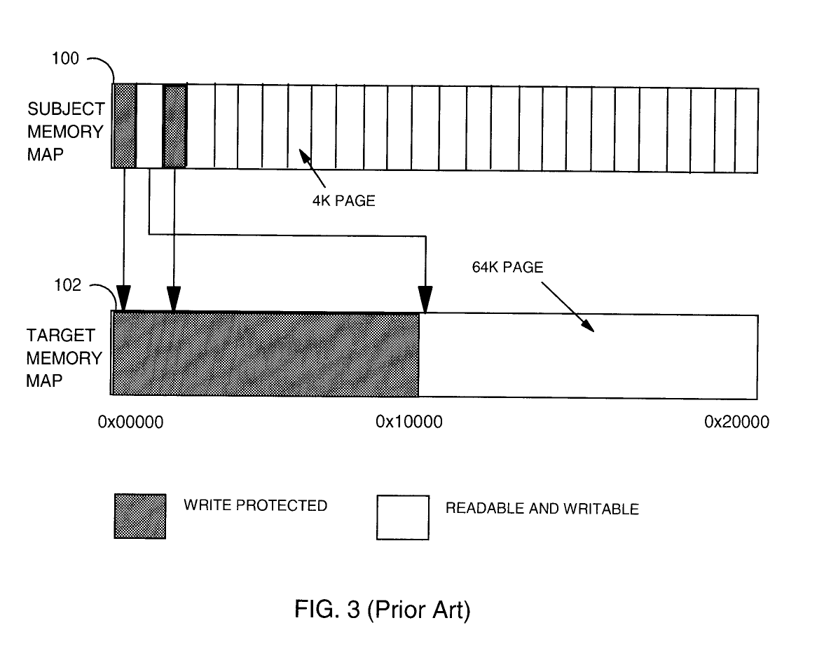

FIG. 4 shows, in simplified schematic form, an improved arrangement of subject and target memories having file-backed and anonymous memory according to the prior art;

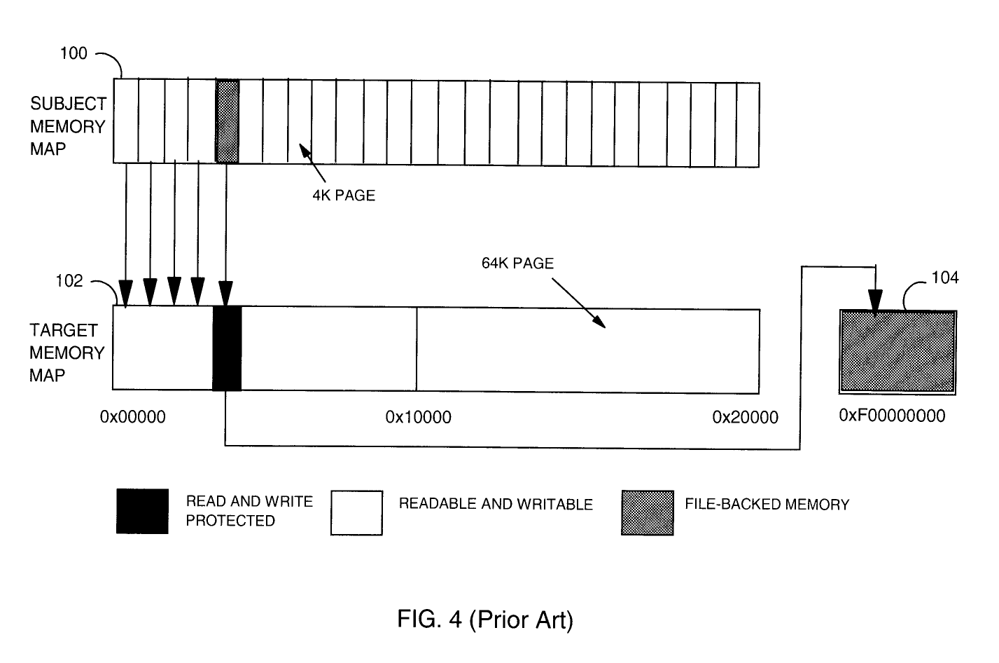

FIG. 5 shows, in simplified schematic form, an apparatus or arrangement of physical or logical components according to a preferred embodiment of the present invention;

FIG. 6 shows, in flowchart form, a method of operation of a system according to a preferred embodiment of the present invention;

FIG. 7 shows, in simplified schematic form, an arrangement of subject and target memories suitable for the implementation of a preferred embodiment of the present invention;

FIG. 8 shows, in simplified schematic form, an arrangement of subject and target memories according to a preferred embodiment of the present invention;

FIG. 9 shows, in simplified schematic form, an exemplary page map structure according to a preferred embodiment of the present invention; and

FIG. 10 shows, in simplified schematic form, a further exemplary page map structure according to a preferred embodiment of the present invention.

### DETAILED DESCRIPTION OF THE PREFERRED EMBODIMENT

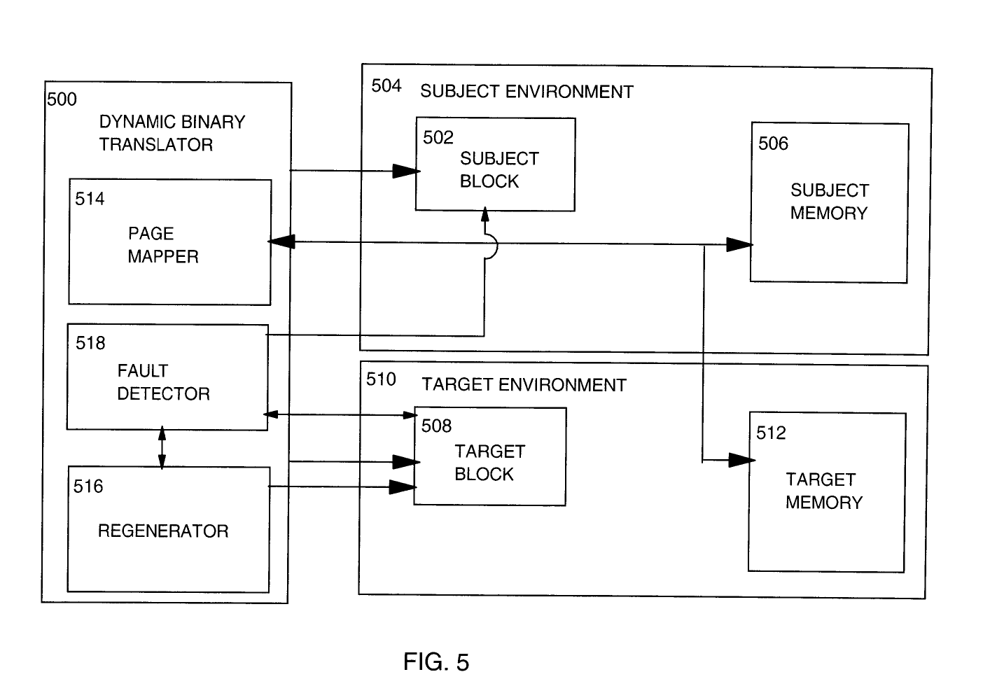

Turning to FIG. 5, there is shown, in simplified schematic form, an apparatus or arrangement of physical or logical components according to a preferred embodiment of the present invention. In FIG. 5 there is shown a dynamic binary translator apparatus 500 for translating at least one first block 502 of binary computer code intended for execution in a subject execution environment 504 having a first memory 506 of a first page size into at least one second block 508 for execution in a second execution environment 510 having a second memory 512 of a second page size, said second page size being different from said first page size. The dynamic binary translator apparatus 500 comprises a redirection page mapper 514 responsive to a memory page characteristic of the first memory 506 for mapping at least one address of the first memory 506 to an address of the second memory 512. The dynamic binary translator apparatus 500 additionally comprises a memory fault behaviour detector 516 operable to detect memory faulting during execution of the second block 508 and to accumulate a fault count to a trigger threshold and a regeneration component 518 operable in response to the fault count reaching the trigger threshold to discard the second block 508 and cause the first block 502 to be retranslated into a retranslated version of the second block 508 with memory references remapped by a page table walk.

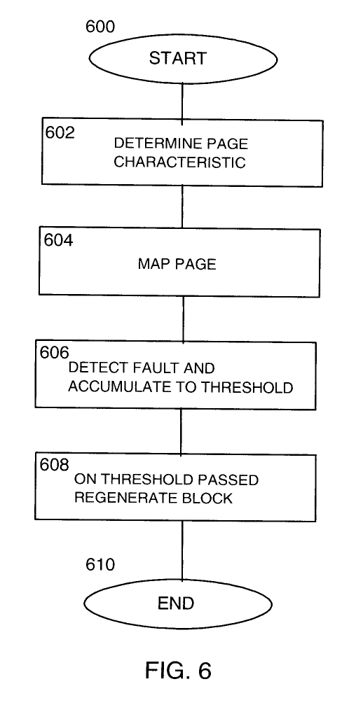

Viewed in terms of a method of operating a system according to the preferred embodiment of the present invention, attention is now drawn to FIG. 6, which shows in flowchart form, a method of operation of a dynamic binary translator according to a preferred embodiment of the present invention.

In FIG. 6 are shown the steps of the method of operating a dynamic binary translator for translating at least one first block of binary computer code intended for execution in a subject execution environment having a first memory of a first page size into at least one second block for execution in a second execution environment having a second memory of a second page size, the second page size being different from said first page size, beginning at START step 600 and comprising the steps of determining 602 a memory page characteristic of the first memory and mapping 604 by a redirection page mapper at least one address of said first memory to an address of said second memory. At step 606, the memory fault behaviour detector detects memory faulting during execution of the second block and accumulates a fault count to a trigger threshold. At step 608 in response to the fault count reaching the trigger threshold, the dynamic binary translator's regeneration component discards the second block and causes the first block to be retranslated into a retranslated version of the second block with memory references remapped by a page table walk. The process ends at END step 610.

The proposed mechanism, whether realised in hardware, software, or a combination of hardware and software, thus provides a means for supporting mixed map types within a single target page sized region without requiring additional operating system modification, but providing good performance characteristics for a wide range of application behaviours.

Where possible, subject program mapping requests are provided at the requested location; that is, where only a single map type is required and there are no file offset constraints which may not be fulfilled, the map is placed directly in subject-accessible memory and no additional address translation is required. When such a direct mapping is not possible, the map is placed in a suitable region of memory accessible by the translator but not directly by the subject program. The corresponding portion of the subject-visible address space is then marked as inaccessible, such that accesses will fault. When an access is made to such a region, a fault is handled and the correct access is performed by the signal handler.

In the first preferred embodiment, there is provided a means of mode switching from fault handling to page table lookups based on observed application behaviour. When a large number of faults are seen within a short period of time, the translator destroys all executable code that it has generated, and begins generating code that performs a page table walk for each access, which will translate the address to the appropriate location in the target virtual address space. Note that the fault handling mechanism remains in place if required. A page table is generated by the translator which provides the mapping from subject addresses to the appropriate target addresses.

In a further preferred embodiment, there may be provided a means for using partial page table walks with a mostly linear subject to target address mapping to reduce lookup overhead. As an optimisation, the page table is filled out only for those pages which require translation; other entries in the page table are marked as empty, and when such entries are encountered the lookup ceases early and the original untranslated address is used. The use of a page table itself is known in the art; however the use of a page table where most addresses map directly without translation and a shortcut path is available is an advantageous improvement upon the known art.

As a further optimisation, means for the exclusion of accesses from page lookup overhead based on a static translation time assessment of the access type is provided. In this optimisation, accesses which are deemed unlikely to require address translation may be performed without a page table lookup; for example, accesses to the stack may be easily detected at code translation time, and are unlikely to require access to file backed maps or shared memory.

In one alternative there may be provided a means for per-access switching of access mode. In this optimisation, all code may be generated without page table lookups, and individual blocks of code may be regenerated to include lookups when faults are observed at those addresses.

A further alternative provides a masked comparison of addresses as a low-cost runtime filter to determine when an address lookup is required. In this alternative approach, a variable bit mask may be used to filter out accesses which will require address translation, by applying a mask to each address and comparing with a known value to determine if the address lies within a range where lookups are known to be required.

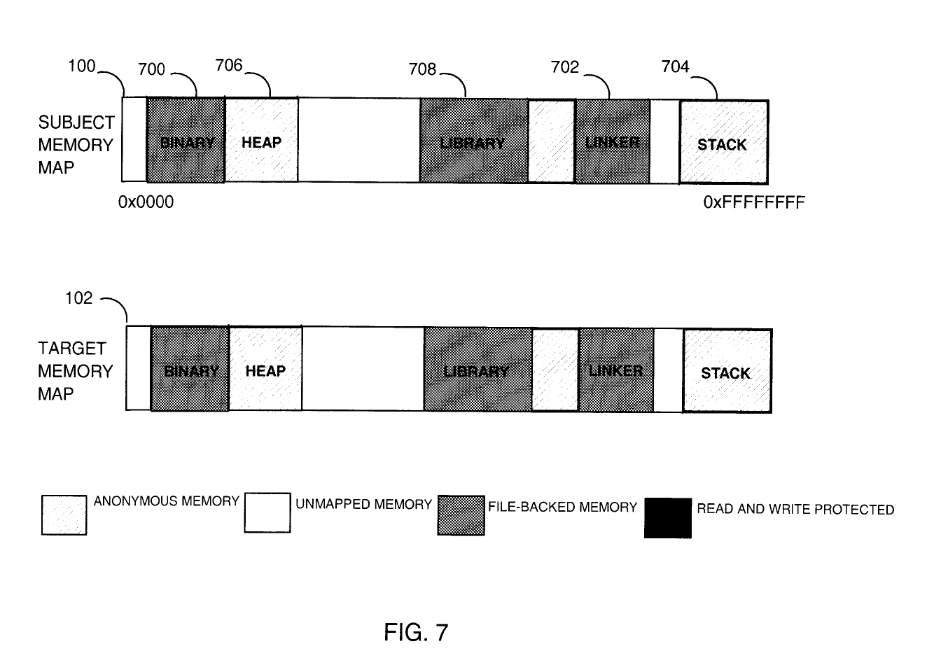

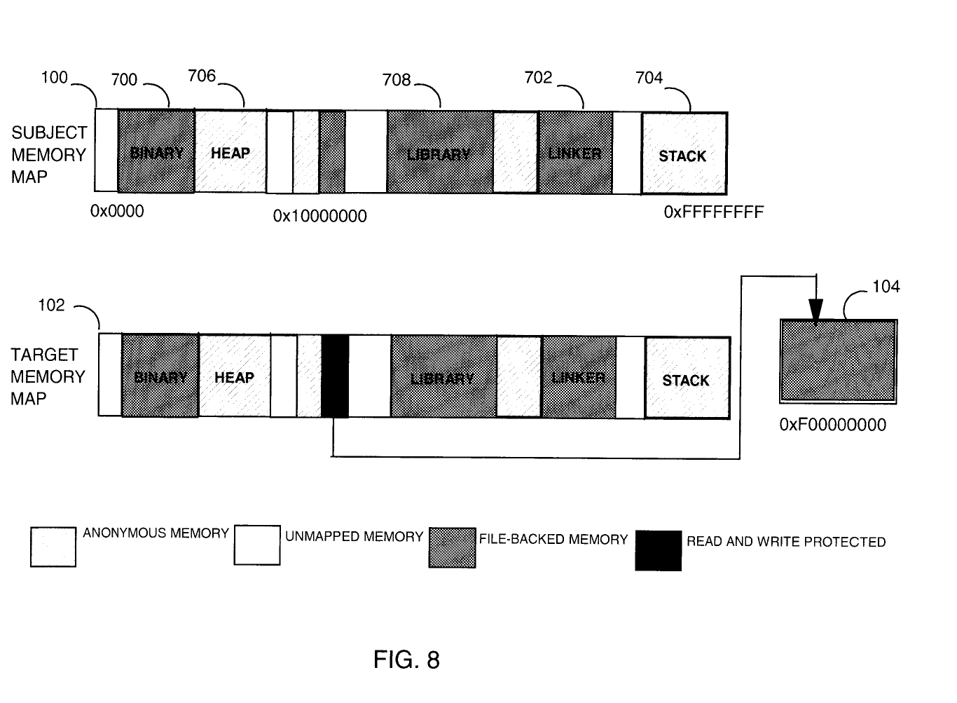

The details of the invention are best described with a worked example, set forth herein as FIGS. 7 and 8, as will be described in detail below. For this description, it is assumed that the subject page size is 4 k, and the target page size is 64 k. It is also assumed that page protection may be applied at a 4 k granularity, using a facility such as the subpage_prot system call provided on Power Linux. If such a feature was not available however, a software implementation of protection such as those described above could be used in its place. It will be clear to one of ordinary skill in the art that many other page size characteristics may be treated in an equally advantageous manner by embodiments of the present invention.

Turning to FIG. 7, exemplary subject page map 100 and exemplary target page map 102 are shown. To begin with, the subject program's binary 700, dynamic linker 702, stack 704, and heap 706 are mapped in by the translator. As the program is executed by the translator, one or more runtime libraries 708 are also mapped in. In this example, all of these mappings may be made directly, without the need for the extra facilities that the preferred embodiment of the present invention provides.

For each instruction encountered in the subject program, the translator generates equivalent instructions that can be executed on the target architecture; for loads and stores, no special address manipulation is performed and memory is accessed directly. Now the subject program maps in a page of anonymous memory at b 0x10000000, followed by a page of file-backed memory at address 0x10001000. The target operating system cannot support this mapping, so the translator must place the file backed memory in a different part of the address space, and mark the page at 0x10001000 as inaccessible. This situation is shown in FIG. 8.

When an attempt is made to access the page at address 0x10001000, a fault is received, and the translator catches this, calculates the correct address to access within the mapping 104 at 0xF00000000, and performs the access at that address.

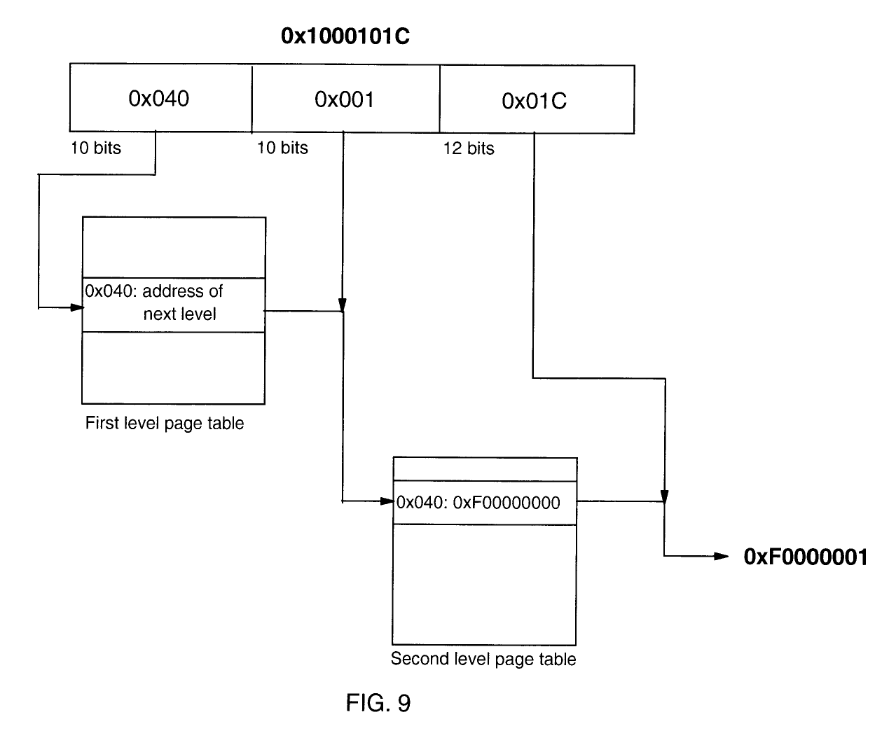

In a first preferred embodiment, there is thus provided a method and apparatus for dynamic mode switching from fault handling to page table lookups based on observed application behaviour. If many accesses are made to this file-backed map at 0x10001000, the performance of the application will be dominated by the cost of handling these faults and performing the appropriate address translation in the fault handler. Note that the cost of performing the access in this way, including the cost of the fault handling, is likely to be two or three orders of magnitude greater than accessing the memory directly. On receiving each fault, the translator may record the total number of faults, and if a large enough number are received, or if a high enough rate of faults within a given time period is observed, the translator may switch into a different mode of operation, in which address translation is performed at runtime for each access, so as to avoid the cost of the fault. The translator generates a page table mapping subject addresses to target addresses. For most addresses, the page table will actually map the subject address back to the same target address, as most maps are still mapped in the equivalent place. However, for the file access in question, the page table will map the address to the target address relative to 0xF00000000. The page table could be constructed similarly to the page tables used by the Intel IA-32 architecture, as described by the manual referred to above. However, the page table need not record information about the map's protection, as page protection may still be handled using the existing features of the operating system. If the address to be accessed is 0x1000101C, the relevant parts of the page tables may be as shown in FIG. 9.

All generated code is now discarded and regenerated but now, instead of generating a simple load or store instruction for each subject load or store, a page table lookup is generated to calculate the correct address. In an exemplary embodiment in code, for a subject instruction:

loadb r1,r2(r3) # load byte from address (r2+r3), place the result in r1

there would result a target instruction sequence:

| | |
|---|---|
| add r12, r2, r3 | # calculate the subject address by adding the two address registers |
| sr r13, r12, 22 | # get the top 10 bits of the address |
| sl r13, r12, 3 | # get the index into the first level table by multiplying by 8 |
| | (each entry is an 8 byte address) |
| ld r13, r13(r30) | # load the address from the first level page table (r30 here |
| | contains the address of the first level table) |
| sr r14, r12, 12 | # get the top 20 bits of the address |
| and r14, r14, 0x3ff | # get the second 10 bits of the address, the index into the second |
| | level table |
| sl r14, r14, 3 | # get the index into the second level table by multiplying by 8 |
| ld r15, r13, r14 | # load the page address from the second level table |
| and r16, r13, 0xfff | # get the offset into the page from the subject address |
| lb r1, r15, r16 | # load from the new page address + the page offset |

To reduce the number of additional checks required, any pages which are not mapped may have their page table entries directed to a known unmapped region of memory so that an appropriate fault will be generated. To deal with addresses which cross page boundaries, some additional instructions may be required in this sequence.

In one embodiment, a partial page table walk with a mostly linear subject to target address mapping to reduce lookup overhead may be implemented. With the scheme described above, it is of course possible to place the target maps in arbitrary locations, as a complete subject to target mapping is provided. However, given that in most cases the address can be mapped in at a target address identical to the requested subject address, in most cases the lookup would simply return the same address. Because of this, an optimisation is available which allows the full lookup to be bypassed in favour of a quicker check of just the first level table. In this scheme, when the full range of addresses covered by a single entry in the first level page table (a range of 4 MB in the scheme shown above) do not require any special handling, the entry in the first level table may contain a special marker value, rather than a pointer to the next table. Having loaded the address from the first level table, if this value is found the rest of the lookup is aborted and the original address is used instead. An example code sequence for this is shown below.

In an exemplary code example, for a subject instruction:

loadb r1,r2(r3) # load byte from address (r2+r3), place the result in r1

there would result a target instruction sequence:

| | |
|---|---|
| add r12, r2, r3 | # calculate the subject address by adding the two address registers |
| sr r13, r12, 22 | # get the top 10 bits of the address |
| sl r13, r12, 3 | # get the index into the first level table by multiplying by 8 (each |
| | entry is an 8 byte address) |
| ld r13, r13(r30) | # load the address from the first level page table (r30 here contains |
| | the address of the first level table) |
| cmp r13, 0 | # compare with zero (zero is used here as the ‘empty’ marker value) |
| beq normal | # branch to the normal load if equal |
| sr r14, r12, 12 | # get the top 20 bits of the address |
| and r14, r14, 0x3ff | # get the second 10 bits of the address, the index into the second |
| | level table |
| sl r14, r14, 3 | # get the index into the second level table by multiplying by 8 |
| ld r15, r13, r14 | # load the page address from the second level table |
| and r16, r13, 0xfff | # get the offset into the page from the subject address |
| lb r1, r15, r16 | # load from the new page address + the page offset |
| b end | # branch past the normal load |
| normal: | |
| lb r1, r2(r3) | # load byte from address (r2 + r3), place the result in r1 |
| end: | |

The instructions used in the common path are shown in bold type; those which are avoided by this optimisation are shown in italics. Here several instructions are saved in the common case, resulting in better overall performance if the majority of accesses do not require address translation.

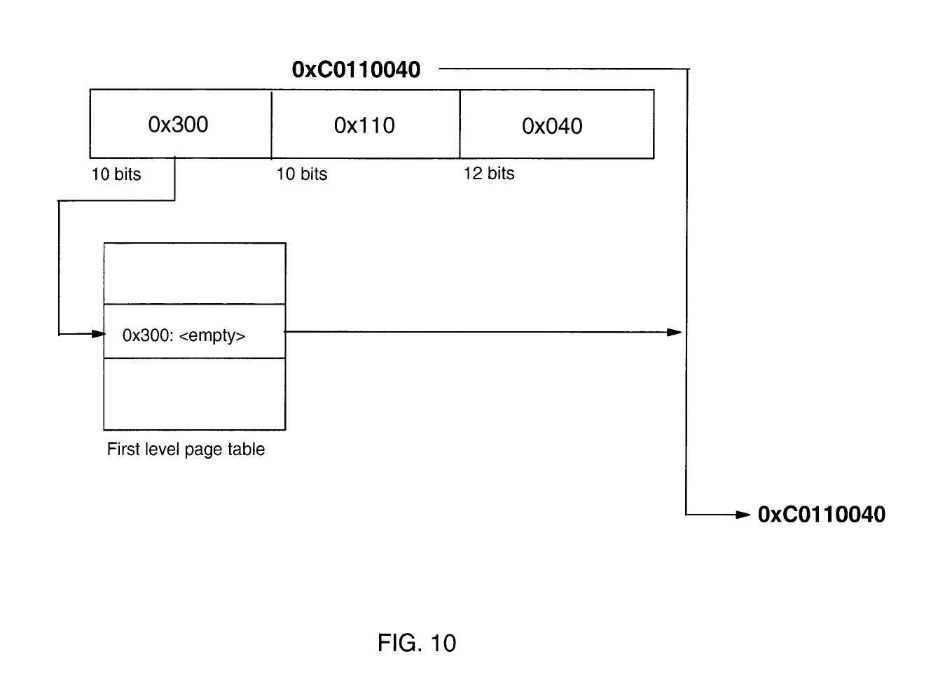

FIG. 10 shows an example of how the page table would look in this situation, when the system is accessing the address 0xc0110040.

In a further enhancement, there may be provided a means of excluding certain accesses from the page lookup overhead based on a static translation time assessment of the access type.

In some subject architectures, architectural features or common conventions make it possible to identify likely properties of a memory access based on a static examination of the instruction. For example, in the IA-32 instruction set, push and pop instructions may be used to access the stack. Additionally, the ESP register is almost exclusively maintained as the current stack pointer, while EBP is often used to point to the top of the current stack frame. For some operating systems and environments, properties such as these may be used to remove address translations from accesses which are deemed unlikely to require them. For translation of an IA-32 application, it may be possible to assert that stack accesses are very unlikely to require address translation, as the stack is not likely to be file backed, or shared with another process, and furthermore the exact location and size of the stack is often under the control of the translator itself. Considerable savings in address translation overhead may therefore be achieved by electing not to plant page table lookups for accesses which are based on ESP or EBP. Similar conventions exist for other architectures.

As a failsafe, the original signal handling code is retained, and any accesses for which lookups are not generated will fault and be handled correctly regardless.

A further improvement is available by having the translator record the address of each subject instruction which faults before any lookups are planted. When it is determined that lookups are required, they may be planted only for those addresses which are known to have faulted. As execution continues, lookups are added to instructions for which faults are seen, by regenerating code for specific sequences of instructions as required. This ensures that a minimum of lookups are generated, ensuring high performance for code which never accesses memory which is not mapped at the requested location. As application behaviour is liable to change over time, it may also be useful to periodically remove all lookup code and start profiling again, thus ensuring that code which no longer requires lookups will not continue to pay the performance penalty.

As an alternative filtering mechanism, a mask and compare operation may be used if the range of commonly accessed addresses for which translation is required is small and contiguous. In the examples above, only a single page required address translation. Whenever such a situation exists, a more optimal address filtering approach may be employed simply by masking the address and comparing to a specific bit value. The mask and the value currently in use may be kept in registers to avoid generating additional load instructions. An example code sequence for this optimisation is shown for the following subject instruction:

loadb r1,r2(r3) # load byte from address (r2+r3), place the result in r1

Which results in the following target instruction sequence:

| | |
|---|---|
| add r12, r2, r3 | # calculate the subject address by adding the two address registers |
| and r13, r12, r29 | # mask the address with the value in r29 (the current address mask |
| | value) |
| cmp r13, r28 | # compare the result with the value in r28 (the current address |
| | comparison value) |
| bne normal | # if the values do not match, assume that not translation is required |
| sr r13, r12, 22 | # get the top 10 bits of the address |
| sl r13, r12, 3 | # get the index into the first level table by multiplying by 8 (each |
| | entry is an 8 byte address) |
| ld r13, r13(r30) | # load the address from the first level page table (r30 here contains |
| | the address of the first level table) |
| sr r14, r12, 12 | # get the top 20 bits of the address |
| and r14, r14, 0x3ff | # get the second 10 bits of the address, the index into the second |
| | level table |
| sl r14, r14, 3 | # get the index into the second level table by multiplying by 8 |
| ld r15, r13, r14 | # load the page address from the second level table |
| and r16, r13, 0xfff | # get the offset into the page from the subject address |
| lb r1, r15, r16 | # load from the new page address + the page offset |
| b end | # branch past the normal load |
| normal: | |
| lb r1, r2(r3) | # load byte from address (r2+ r3), place the result in r1 |
| end: | |

The instructions used in the common path are shown in bold type; those which are avoided by this optimisation are shown in italics. Here several instructions are saved in the common case, resulting in better overall performance if the majority of accesses do not require address translation.

As execution proceeds and the memory map is changed, the current mask and address comparison values may be updated accordingly.

It will be clear to one of ordinary skill in the art that all or part of the method of the preferred embodiments of the present invention may suitably and usefully be embodied in a logic apparatus, or a plurality of logic apparatus, comprising logic elements arranged to perform the steps of the method and that such logic elements may comprise hardware components, firmware components or a combination thereof.

It will be equally clear to one of skill in the art that all or part of a logic arrangement according to the preferred embodiments of the present invention may suitably be embodied in a logic apparatus comprising logic elements to perform the steps of the method, and that such logic elements may comprise components such as logic gates in, for example a programmable logic array or application-specific integrated circuit. Such a logic arrangement may further be embodied in enabling elements for temporarily or permanently establishing logic structures in such an array or circuit using, for example, a virtual hardware descriptor language, which may be stored and transmitted using fixed or transmittable carrier media.

It will be appreciated that the method and arrangement described above may also suitably be carried out fully or partially in software running on one or more processors (not shown in the figures), and that the software may be provided in the form of one or more computer program elements carried on any suitable data-carrier (also not shown in the figures) such as a magnetic or optical disk or the like. Channels for the transmission of data may likewise comprise storage media of all descriptions as well as signal-carrying media, such as wired or wireless signal-carrying media.

A method is generally conceived to be a self-consistent sequence of steps leading to a desired result. These steps require physical manipulations of physical quantities. Usually, though not necessarily, these quantities take the form of electrical or magnetic signals capable of being stored, transferred, combined, compared, and otherwise manipulated. It is convenient at times, principally for reasons of common usage, to refer to these signals as bits, values, parameters, items, elements, objects, symbols, characters, terms, numbers, or the like. It should be noted, however, that all of these terms and similar terms are to be associated with the appropriate physical quantities and are merely convenient labels applied to these quantities.

The present invention may further suitably be embodied as a computer program product for use with a computer system. Such an implementation may comprise a series of computer-readable instructions either fixed on a tangible medium, such as a computer readable medium, for example, diskette, CD-ROM, ROM, or hard disk, or transmittable to a computer system, via a modem or other interface device, over either a tangible medium, including but not limited to optical or analogue communications lines, or intangibly using wireless techniques, including but not limited to microwave, infrared or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable medium with accompanying printed or electronic documentation, for example, shrink-wrapped software, pre-loaded with a computer system, for example, on a system ROM or fixed disk, or distributed from a server or electronic bulletin board over a network, for example, the Internet or World Wide Web.

In a further alternative, the preferred embodiment of the present invention may be realized in the form of a data carrier having functional data thereon, said functional data comprising functional computer data structures to, when loaded into a computer system and operated upon thereby, enable said computer system to perform all the steps of the method.

It will be clear to one skilled in the art that many improvements and modifications can be made to the foregoing exemplary embodiment without departing from the scope of the present invention.

1. A dynamic binary translator apparatus for translating at least one first block of binary computer code intended for execution in a subject execution environment having a first memory of a first page size into at least one second block for execution in a second execution environment having a second memory of a second page size, said second page size being different from said first page size; and comprising:
a redirection page mapper responsive to a memory page characteristic of said first memory for mapping at least one address of said first memory to an address of said second memory;
a memory fault behaviour detector operable to detect memory faulting during execution of said second block and to accumulate a fault count to a trigger threshold; and
a regeneration component operable in response to said fault count reaching said trigger threshold to discard said second block and cause said first block to be retranslated into a retranslated block with memory references remapped by a page table walk.

2. A dynamic binary translator apparatus as claimed in claim 1, wherein said memory page characteristic of said first memory comprises a page protection characteristic.

3. A dynamic binary translator apparatus as claimed in claim 1, wherein said memory page characteristic of said first memory comprises a file-backed memory characteristic.

4. A dynamic binary translator apparatus as claimed in claim 1, wherein said regeneration component is further operable to bypass said page table walk where said mapping at least one address of said first memory to an address of said second memory returns a same address.

5. A dynamic binary translator apparatus as claimed in claim 1, wherein said regeneration component is further operable to bypass said page table walk where a memory access is identified as a memory access to a memory of a type not requiring remapping.

6. A method of operating a dynamic binary translator for translating at least one first block of binary computer code intended for execution in a subject execution environment having a first memory of a first page size into at least one second block for execution in a second execution environment having a second memory of a second page size, said second page size being different from said first page size; and comprising the steps of:
responsive to a memory page characteristic of said first memory, mapping by a redirection page mapper at least one address of said first memory to an address of said second memory;
detecting, by a memory fault behaviour detector, memory faulting during execution of said second block and accumulating a fault count to a trigger threshold; and
in response to said fault count reaching said trigger threshold, discarding by a regeneration component said second block and causing said first block to be retranslated into a retranslated block with memory references remapped by a page table walk.

7. A method as claimed in claim 6, wherein said memory page characteristic of said first memory comprises a page protection characteristic.

8. A method as claimed in claim 6, wherein said memory page characteristic of said first memory comprises a file-backed memory characteristic.

9. A method as claimed in claim 6, wherein said regeneration component is further operable to bypass said page table walk where said mapping at least one address of said first memory to an address of said second memory returns a same address.

10. A method as claimed in claim 6, wherein said regeneration component is further operable to bypass said page table walk where a memory access is identified as a memory access to a memory of a type not requiring remapping.

11. A computer program comprising computer program code to, when loaded into a computer system and executed thereon, cause said computer system to perform the steps of a method as claimed in claim 6.
